(19) United States
(12) Patent Application Publication
(10) Pub. No.: US 2022/0306443 A1
(43) Pub. Date: Sep. 29, 2022

(54) PROTECTION DEVICE, METHOD AND APPARATUS FOR A CONTAINER

(71) Applicants: Uberto RAVAZZONI, Tizzano Val Parma (PR) (IT); Massimo LUNETTI, Milano (IT)

(72) Inventors: Uberto RAVAZZONI, Tizzano Val Parma (PR) (IT); Massimo LUNETTI, Milano (IT)

(21) Appl. No.: 17/610,850

(22) PCT Filed: May 14, 2020
(86) PCT No.: PCT/IB2020/054589

§ 371 Date: Nov. 12, 2021

(30) Foreign Application Priority Data
May 15, 2019 (IT) 102019000006868

(51) Int. Cl. B67B 5/03; B65D 17/28

(52) U.S. Cl. CPC B67B 5/034; B65D 17/4012; B65D 2517/0098

(57) ABSTRACT

A container for food products or beverages is provided onto which a protection device is applied. The container includes a body, to which a closing member is firmly connected, the upper surface of which may carry an opening member for releasing contents contained therein. The protection device includes a film with at least one covering surface, each respective part or zone of which adheres to the opposite part or zone of the surface of the container to be covered and protected.

### FIELD OF THE INVENTION

The present invention relates to a container for food products or beverages, in particular hermetically sealed, disposable, typically non-reclosable, intended for primary packaging, on which a hygienic protection device is applied which prevents contamination of the lid that can be opened from production until the moment of use of the contents, in order to ensure hygienically convenient conditions of consumption.

The device is incorporated by means of an embodiment method which uses an apparatus particularly suitable for said function.

### BACKGROUND

Containers for food products or beverages are products whose use is very widespread.

They can consist of different metallic materials such as, for example but not exclusively, aluminum or steel.

Typically, a steel can is made up of three pieces, with the body having a cylindrical or rectangular section, closed by welding or crimping, the lid and bottom always applied by crimping.

An aluminum can is usually made up of two pieces; the cylindrical body and the bottom are obtained by deep drawing, the molded lid is applied by crimping.

Beverage cans are very popular, also thanks to the fact that they do not require specific tools for opening, but simply the actuation of an opening member, normally called tab, which preferably remains joined to the container.

However, in particular during the transport and storage phases, said containers risk being contaminated by physical, chemical and biological agents.

During and after opening the can, the contents can in turn get contaminated, coming into contact with the external surface of the container, even in an extremely dangerous way for the health of the consumer.

Said problem also occurs due to the shape of the opening member which is generally made in such a way that during opening part of the lid is introduced into the container and comes into contact with the contents.

Furthermore, the improper use of drinking directly from the can, as if it were a glass, bringing the mouth in direct contact with the contaminated surface, is very widespread.

Some attempts to protect the cans during storage and transport with means ranging from multiple encapsulation up to single caps/seals, in aluminum or plastic, coupled as coverings to the lid of the container, are known in the state of the art.

Although a certain degree of protection of the can surface from coarse dirt deposits is guaranteed by said systems, they have generally not been successful due, for example, to the presence of oxygen and humidity owing to the imperfect adherence between the protection and the lid or the permeability of the materials used. In fact, the closed spaces between covering and lid, subjected to the action of heat and light, in the presence of oxygen and humidity, become an excellent space for the proliferation of microorganisms.

Furthermore, said protections do not fully adhere to the surface to be protected, therefore there is no guarantee that they will effectively remain in place until the can is opened for the consumption of its contents.

Protection devices applied in the liquid state which solidify successively, when they are already applied to the can, are also known in the state of the art. Said solutions perfectly follow the shape of the can and therefore do not present the problems mentioned above for the protections of the lid type.

The problem with protection devices made using liquid solutions is that of not being adequately suitable for the contact with food.

In fact, the substances/solutions/liquid suspensions used have a residual portion of free monomers after hardening which are not free of migration phenomena.

In particular, it is found that the faster the solidification of the liquid phase, the greater the residual portion of free monomers and this is what happens in the case of can filling plants, which generally have very high rates and do not allow adequate solidification times.

### SUMMARY

The technical problem underlying the present invention is to make available a container for food products or beverages with protection device and related method and application apparatus, structurally and functionally designed to overcome one or more of the limits set forth above with reference to the known prior art.

In the context of aforesaid problem, a main object of the invention is to develop a container for food products or beverages with protection device and related method and application apparatus, which allows to protect the external surface of the container, which normally comes into contact with the contents during its opening and subsequent consumption, in a hygienically safe manner.

An object of the present invention is to make available to the art a container for food products or beverages with protection device and related method and application apparatus, within the framework of a simple, rational solution that allows the achievement of high production rates.

These and other objects are reached by the characteristics of the invention as set forth in the independent claims. The dependent claims outline preferred and/or particularly advantageous aspects of the invention.

In particular, an embodiment of the present invention makes available a container for food products or beverages, in particular a can, comprising a body, to which a closing member, or lid, is firmly connected, the upper surface of which may carry an opening member to release the contents, on which container a protection device is applied comprising a film with at least one covering surface adhering in each of its parts or zones to the respective opposite part or zone of the surface of said container to be covered and protected.

Thanks to the characteristics of the film used and the application process, both adherence, that is the perfect contact of the opposite surfaces and the adhesion, that is the bonding of the film on the lid, are achieved, both of fundamental importance for the effectiveness of the protection.

In particular, said film extends to cover the entire upper accessible surface of the closing member of the container.

Each part or zone of the film is completely adherent on the entire external surface of the closing member and in particular has the characteristic of adhering/bonding to the protrusions and/or recesses that are present on the upper surface and on the opening member.

Together with other aspects of the device described below, this prevents the presence of air and humidity between the upper surface of the closing member or lid and the covering surface of the film, blocking the proliferation of microorganisms.

According to an aspect of the invention, the film comprises a side covering surface which extends beyond the upper surface, going to adhere to the outer edge of the closing member.

Thanks to this aspect, the sealing of the upper surface of the container is better guaranteed, improving the prevention of external contaminations.

To further guarantee this aspect, a feature of the invention provides that the side portion of the film is anchored in the interspace between the side surface and the outer edge of the closing member.

Said anchoring and sealing effect has also the function of further increasing the firmness of the device.

Preferably the film is of the gas impermeable type and preferably multilayer.

This aspect guarantees the barrier effect of the protection device against vapors and gases.

An aspect of the invention is that the adhesion/bonding of the film to the surface of the closing member of the container reaches values such that it can remain peelable manually and therefore allow easy removal of the protection at the moment of consumption.

Another aspect of the invention is that of making available a process for the protection of a container for food products or beverages, in particular a can, by a protection device, comprising a film, characterized in that it provides for arranging the film at the surface portion to be protected and for adhering each part or zone of the covering surface to the respective opposite part or zone of the surface of said container to be covered and protected.

Thanks to this process, a hygienically effective application of the protection device is guaranteed.

Said process preferably provides for applying the protection device according to at least one positioning step for positioning and holding the film above and in the proximity of the surface portion to be protected, in particular of the closing member, and an application step for applying the film to the container.

Said application step provides for:
creating the vacuum on both sides of the film, balancing the pressure values so that the same film does not contact the closing member of the container;
upon reaching the desired degree of vacuum below the film, restoring the atmospheric pressure or possibly a certain overpressure above the film, while maintaining the vacuum below the film, so as to push, press, and adhere the covering surface of the film against the upper surface of the container, and preferably push, press, and adhere the side portion of the film on the outer edge of the closing member of the container and preferably also on a portion of the side surface of the body below the closing member, and further preferably inserting said side portion of the film into the interspace that is present between the side surface of the body and the outer edge of the closing member;
restoring the atmospheric pressure also below the film;
preferably making the film suitably shapeable during the step, for example by heating.

The advantages of said application in particular by vacuum are due to the fact that the film:
closely follows the profile of the container, thus being inserted into interspaces and recesses without however totally incorporating appendixes of the container, such as for example the opening member, which would make it impossible to remove the protection later;
does not retain air bubbles, even in the most inaccessible recesses, such as for example below the opening member, thanks to the vacuum that, created during the application phase, is kept throughout the whole shelf life of the product;
bonds on the whole accessible surface of the lid of the container, not only on limited portions of said surface.

The fact of remaining under vacuum is further guaranteed by the barrier property of the film used against vapors and gases, so as to prevent the proliferation of microorganisms.

Another aspect of the invention is that of making available an apparatus for the protection of a container for food products or beverages, in particular a can, by applying a protection device, said apparatus which comprises application means configured to apply the film in so that each part or zone of the covering surface is adhering and bonds to the respective opposite part or zone of the surface of said container to be covered and protected.

Thanks to said apparatus it is possible to create an application system which, in addition to allowing the advantages described above with respect to the process, is simple and with low costs.

Furthermore, a hygienically effective application is ensured with appropriate application times for the high rates of the container filling plants.

Said objects and advantages are all achieved by the container for food products or beverages with protection device and related method and application apparatus, object of the present invention, which is characterized by what is provided in the following claims.

### BRIEF DESCRIPTION OF THE DRAWINGS

This and other features will be more apparent from the following description of some of the embodiments, illustrated purely by way of non-limiting example in the accompanying drawings.

FIG. 1: illustrates an axonometric view of a container, in particular a can;

FIG. 2: illustrates a section view of a container, in particular a can;

FIG. 3: illustrates a section view of a portion of the container, in particular a can, on which the protection device is applied;

FIG. 4: schematically illustrates a section of the application apparatus;

FIG. 5: schematically illustrates the steps of application of the device to the container.

### DETAILED DESCRIPTION OF THE PREFERRED EMBODIMENTS

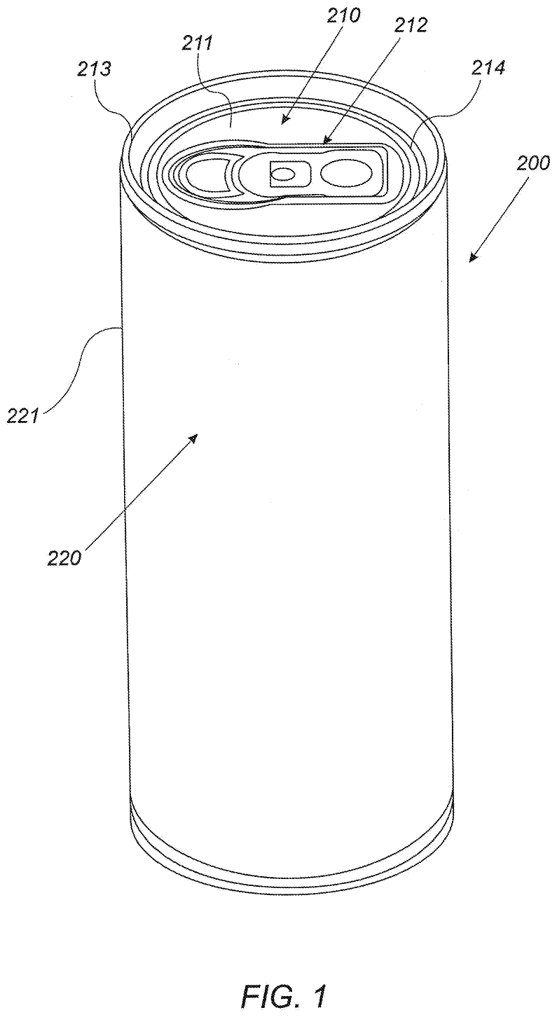

With particular reference to FIG. 1, a container 200 for food products or beverages is shown.

In particular, a can for beverages is represented, which is one of the containers that mostly presents hygienic problems due to its shape and the habits of use of the consumers that are often improper.

In the following the term “can” can be used instead of container, without limiting the scope of protection of the invention.

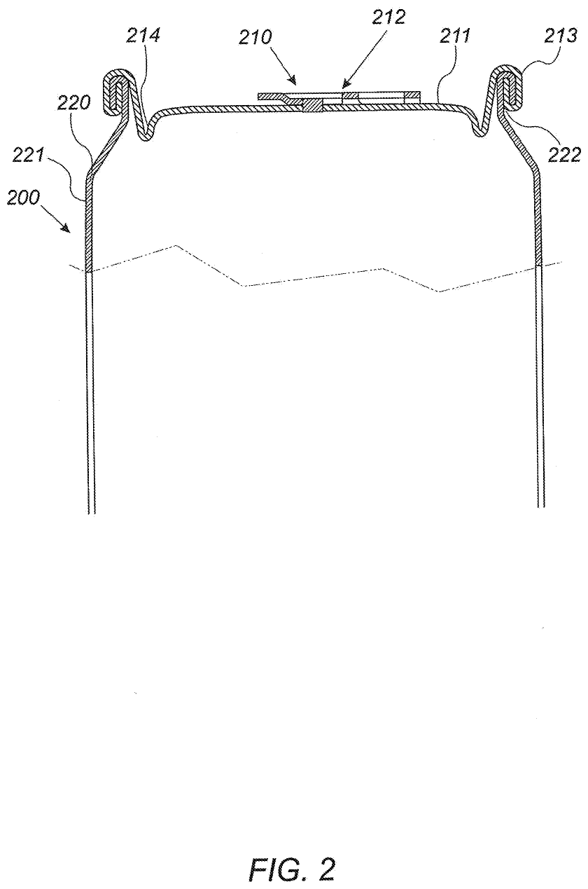

Said type of container 200 generally comprises a body 220 to which a closing member 210, generally called lid, is firmly connected. As shown in FIGS. 1 and 2, the closing member 210 comprises a substantially flat upper surface 211 and a raised outer edge 213.

In FIG. 2, said upper surface 211 comprises a circular recess 214, normally called milling, located in the proximity of the edge 213.

The upper surface 211 may also carry an opening member 212 for outflow of the contained product and in this case of the beverage.

Said opening member protrudes with respect to the upper surface 211 and gives rise to recesses placed between itself and the closing member 210.

The edge 213 is configured to connect the closing member 210 to the body 220 for example by crimping.

Generally, after the normal filling process, the container 200 is closed by, for example, double crimping between the closing member 210 and the body 220 of the can.

An interspace 222 is therefore created between the outer edge 213 of the closing member 210 and a side surface 221 of the body 220.

A container 200 for food products or beverages, in particular a can, on which a protection device 100 is applied, forms the object of the invention.

A preferred embodiment provides that said protection device 100 comprises a film 300.

Said film 300 in turn comprises at least one covering surface 310 of which each respective part or zone is adhering to the opposite part or zone of the surface to be covered and protected of said container 200.

In particular, said covering surface 310 extends to cover the entire upper surface 211 of the closing member 210 of the container 200.

Each respective part or zone of the covering surface 310 of the film 300 is such as to adhere completely to the entire upper surface 211 of the closing member 210 and in particular has the characteristic of going to adhere to all the protrusions that are present on the upper surface 211 and on the opening member 212 and of closing all the recesses that are present between the upper surface 211 and the opening member 212.

The protection device 100 behaves like an adherent skin that bonds in a peelable/removable/non-permanent way, creating the hygienic protection in the same way on the whole affected surface.

More specifically, the covering surface 310 adheres like a skin, which is bonded in each part or zone of contact with the opposite surfaces of the container, for example by entering the circular recess 214 located in the proximity of the edge 213.

This prevents the entry of both contamination and of the gases and vapors between the upper surface 211 and the covering surface 310, also preventing the proliferation of microorganisms.

According to an aspect of the invention, the film 300 comprises a side covering surface 311 which extends beyond the upper surface 211 going to adhere to the outer edge 213 of the closing member 210.

Preferably, the side covering surface 311 extends and adheres on a portion of the side surface 221 of the body 220 below the closing member 210.

Thanks to this aspect, the insulation of the upper surface 211 of the container 200 from external contamination is more guaranteed.

Contrary to what happens with other systems which provide for only partial bonding, and in particular at the raised edge 213, the combination of adherence and adhesion like a skin that characterizes the invention allows to maintain a high degree of hygienic protection even in the presence of punctures of the film 300, since any external contamination is prevented from reaching other points of the surface to be protected that are not strictly those exposed at the puncture itself.

Furthermore, the adhesion/bonding on the entire upper surface 211 and on the opening member 212 together with the characteristic of the device 100 of not being resealable gives the device 100 itself an accessory function as a tamper-proof seal against any accidental or malicious damage.

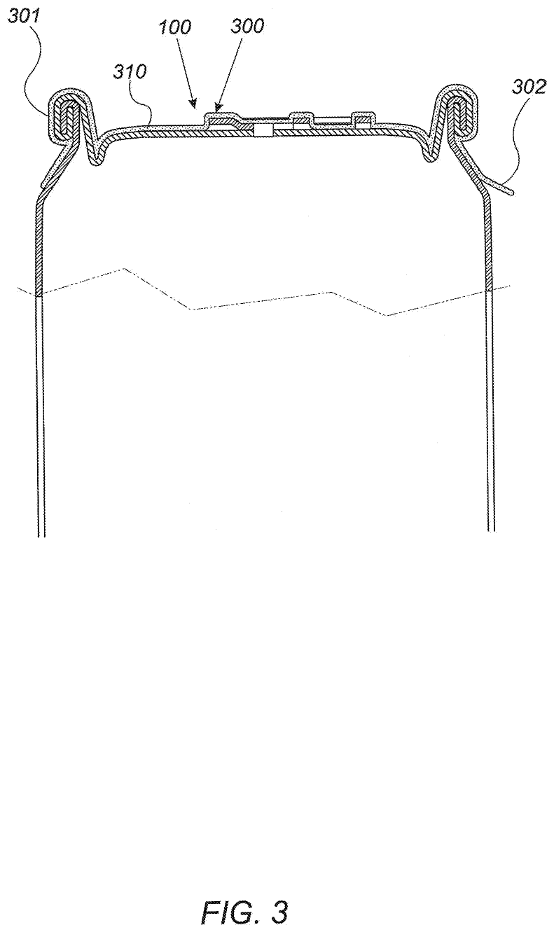

A characteristic of the invention, shown in FIG. 3, provides that the side covering surface 311 of the film 300 enters the interspace 222 present between the side surface 221 and the outer edge 213 of the closing member 210 to further improve the anchoring in place of the device 100 and the sealing of the surface to be protected.

To obtain adhesion, which prevents both the removal and the possible entry of contamination between the protection device 100 and the container 200, the film 300 preferably has adhesive properties.

Said properties are preferably, but not exclusively actuatable by heating the film 300 itself since according to another aspect of the invention, the film 300 is preferably a thermoplastic film.

For example, a type of material that may be suitable for said application is a polyethylene plastic film comprising additives such as to activate adhesive properties for the adhesion to various materials such as for example aluminum or epoxy resins with bisphenol A, with which the surface of the can lid is normally treated.

The type of material used for said films 300 can be, for example, the one normally used for the skin packaging of food products.

In fact, said film 300 further preferably has properties suitable for food use.

A preferred embodiment also provides that the film 300 is of the barrier type, that is to say with limited permeability, preferably impermeable to gases and further preferably of the multilayer type.

In this way the risk that, for example, air may be inserted between the protected surface of the container 200 and the protection device 100, even in case of long stays in storage areas and under improper storage conditions, is further reduced.

The elastoplastic properties of the film are adapted to generate a centripetal radial force which preferably acts at the outer edge 213 and/or the interspace 222 and/or the portion of the side surface 221. This further prevents an accidental removal of the protection device 100.

A possible embodiment provides for exploiting said adhesive properties of the film 300 also to create preferential points of greater anchoring of the film 300 to the container 200, for example by means of differentiated heating, with the aim of preventing that the complete removal of the film 300 from the container 200 leads to the dispersal thereof in the environment.

To facilitate the removal by tearing of the film 300 at the moment of consumption, a preferred embodiment provides that the side covering surface 311 comprises an appendix 302 which remains detached from the side surface 221.

Said appendix 302 offers a holding point to facilitate the removal of the film 300 from the container 200 before its opening for consumption.

The process for the protection of a container 200 for food products or beverages, in particular a can, by a protection device 100 comprising a film 300 forms the object of the invention.

Said process provides for arranging the film 300 at the surface to be protected, so that each respective part or zone of the covering surface 310 is adhering and preferably bonded to the opposite part or zone of the surface to be covered with said container 200.

According to a possible embodiment, the process provides for applying the protection device 100 according to at least the following steps:

Positioning Step:
positioning and holding the film 300 above and in the proximity of the closing member 210;

Application Step:
gradually creating a vacuum on both sides of the film 300, balancing the pressure values so that the same film 300 does not contact the closing member 210 of the container 200,
upon reaching the desired vacuum below the film 300, restoring the atmospheric pressure or possibly a certain temporary overpressure above the film 330, while maintaining the vacuum below the film, so as to push, press, and adhere the covering surface 310 against the upper surface 211, and preferably push, press, and adhere the side portion 301 about the outer edge 213 of the closing member 210 and preferably on a portion of the side surface 221 of the body 220 below the closing member 210, and further preferably inserting said side portion 301 into the interspace 222 that is present between the side surface 221 and the outer edge 213 of the closing member 210,
restoring the atmospheric pressure also below the film 300,

Said process can also comprise a further

Heating Step:
for making the film 300 suitably shapeable during the preceding steps preferably by means of suitably timed heating.

Said steps are not necessarily in the described sequence, but can also be inverted or overlapped.

As will be further described below, a characteristic of the invention provides that the process is in particular carried out inside an apparatus 500 configured to work with controlled pressure and/or vacuum, so as to be able to carry out the steps described above relating to the differentiated generation of the vacuum or the application of any back pressure.

According to a preferred embodiment, the process provides, in the positioning step, for inserting into the apparatus 500 of at least the portion of the container 200 to be protected, comprising the closing member 210 and in particular a portion below it of the body 220. The film 300 is also positioned and held inside the apparatus 500 above and in the proximity of the closing member 210.

The application step provides for eliminating the air between the film 300 and the container 200, preferably reaching the vacuum in the spaces below and above the film 300 according to a suitable synchronism; this has as main purposes:

extracting the residual humidity present on the container 200,

extracting the air,

Upon reaching the vacuum below the film, the atmospheric pressure or alternatively a temporary overpressure is restored above the film 330. Said operation is preferably carried out while maintaining the vacuum below the film 300.

Said operation has the purpose of shaping, pressing and adhering/bonding the covering surface 310 to the upper surface 211 avoiding the formation of air bubbles, which would prevent the “skin effect” described above.

The combined action of the two different pressures/vacuums, the vacuum in the space between film 300 and container 200, and a pressure higher than or equal to the atmospheric pressure above film 300, are functional to optimize the application described above: in fact the attraction of the film 300 towards the surface of the container 200 is combined with the pushing action of said film 300 towards the container.

Similarly, said application step of the process allows the side covering surface 311 to be shaped, pressed and adhered/bonded about the outer edge 213 of the closing member 210.

According to a preferred form, the side covering surface 311 is shaped adhering also to the portion of the side surface 221 of the body 220 below the closing member 210.

Further preferably the side covering surface 311 thanks to the combined action of the pressure and the vacuum manages to insert itself into the interspace 222 that is present between the side surface 221 and the outer edge 213 of the closing member 210.

The advantages of said application are due to the fact that the film 300 completely follows the profile of the container 200 like a skin, being thus inserted into interspaces and recesses without leaving air bubbles or free spaces between the protected surface of the container 200 and the protection device 200.

Preferably the application process can provide for heating the protection device 200 to make the film 300 suitably shapeable.

Thanks to said heating, thermoplastic properties of the film 300 can be activated which allow to effectively shape said film 200 to the surface to be covered; furthermore, in the subsequent cooling, elastic properties of the film 300 can also be exploited so as to generate a centripetal radial force which further prevents the accidental removal of the protection device 100 and which acts preferably at the outer edge 213 and/or the interspace 222 and/or of the portion of the side surface 221.

In the case where the film 300 is thermoadhesive, it is preferably provided for heating the same film until the adhesive properties are also activated.

Said heating is preferably carried out even before the application step, so that the thermoadhesive and/or thermoplastic properties of the film 300 are already activated at the start of the application.

So the film 300 is made to enter and adapt in the interspace 222 thanks to the effect of heat and vacuum; the film 300 takes the shape of the interspace 222, which shape the film 300 maintains when cooled creating a further mechanical and adhesive grip/anchoring, guaranteeing further safety against side infiltrations and removals of the protection device 100.

A possible embodiment provides for carrying out a differentiated heating, only on certain zones of the film 300 in order to increase the adhesive properties by defining preferential points of higher anchoring of the film 300 to the container 200. In this way, the complete removal of the film 300 from the container 200 can be prevented avoiding dispersal in the environment.

Said heating of the film 300, for example, is obtained by irradiation, and/or contact and/or hot air.

In accordance with aforesaid purposes, the process may provide, before the application step, for supporting the side covering surface 311 of the film 300 which extends beyond the upper surface 211, by resting means 540 configured not to generate adhesion with the film 300.

As will be better described below, thanks to said supporting action, the film 300 remains in the correct position until the end of the application step.

To complete the process, a cutting step can also be provided in which the film 300 which remains in excess after application, is cut and removed.

In particular, the removed portion of film 300 is that which for example is supported by the resting means 540; said portion does not adhere to the container 200, therefore it remains detached therefrom and so it is preferable to eliminate it totally or partially.

A preferred embodiment provides that the film 300 is cut leaving an appendix 302 that remains detached from the container 200 and which is functional to defining a holding point for the user who will have to remove the protection device before opening the can.

Therefore, summing up a preferred process of application of the device 100 to the container 200, it can provide for the following steps:

positioning step;

heating step;

application step;

cutting step.

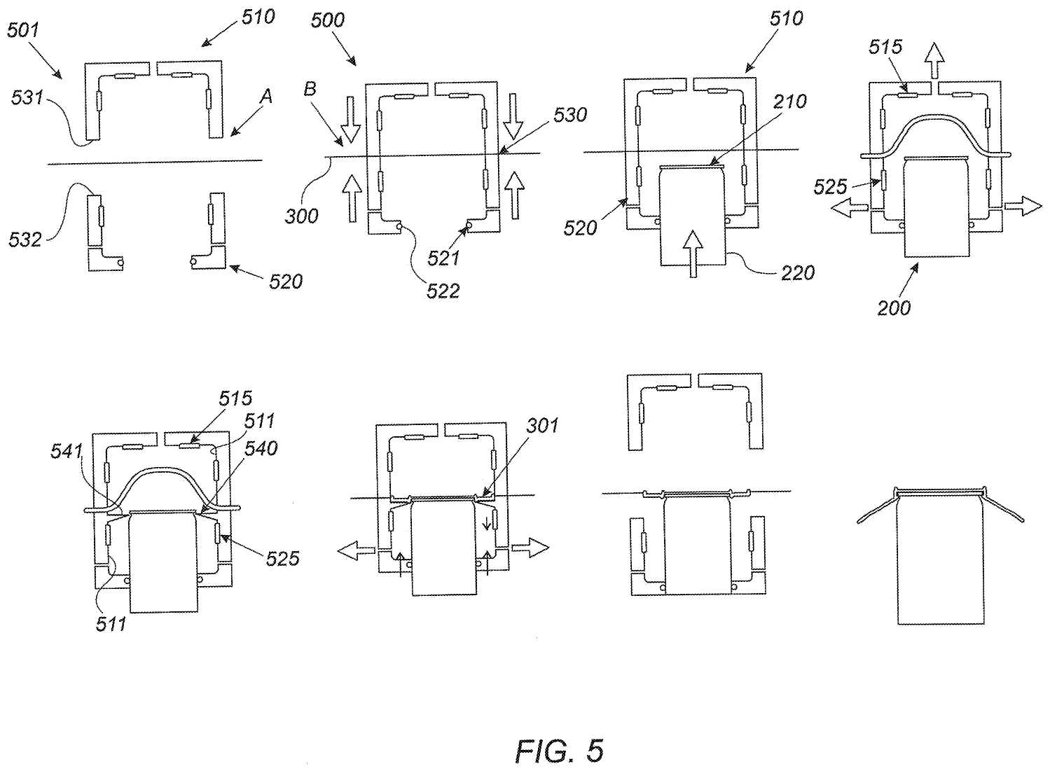

Said process object of the invention is schematically shown in FIG. 5.

It is understood however that what is described above has a value of non-limiting example, therefore, possible variants of detail that may be necessary for technical and/or functional reasons, are considered from now falling within the same protective scope defined by the claims indicated below.

The apparatus 500 for the protection of a container 200 for food products or beverages, in particular a can, by applying a protection device 100 according to the invention.

Said apparatus 500 comprises application means 501 configured to apply the film 300 so that each respective part or zone of the covering surface 310 adheres to the opposite part or zone of the surface to be covered of said container 200.

According to an aspect of the invention, the application means 501 comprise a lower chamber 520 inside which at least the portion of container 200 that must be protected is positioned.

Further the application means 501 comprise blocking means 530 configured to hold the film 300 in place so that it is positioned above the closing member 210 of the container 200.

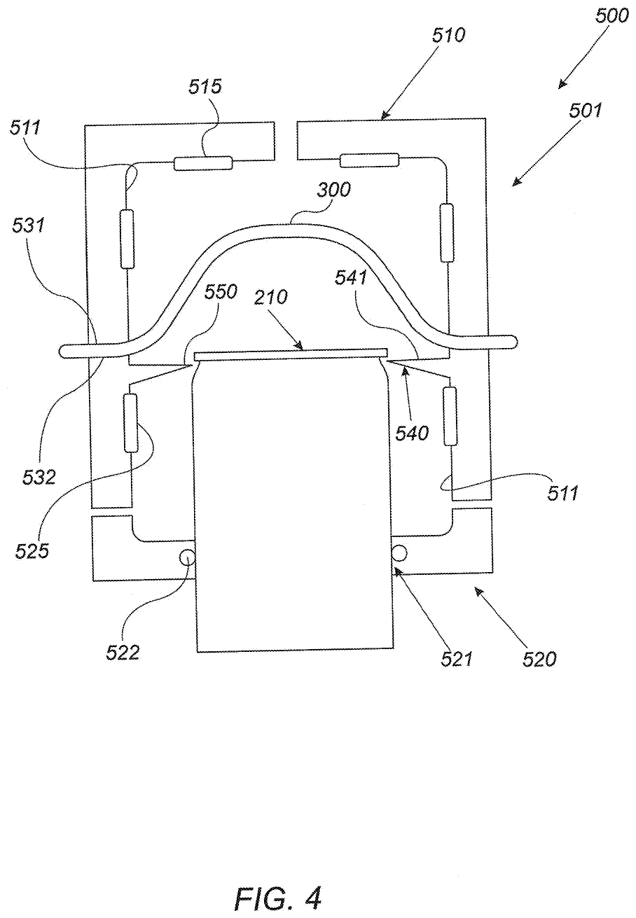

Preferably it is the same film 300 that is arranged in such a way as to define in the apparatus 500 an upper chamber 510 and a lower chamber 520, as shown in FIG. 4.

A characteristic of the invention provides that said upper 510 and lower 520 chambers further comprise depressurization means to generate the vacuum therein in particular above and below the film 300, that is, between the film 300 and the container 200.

Thanks to said depressurization means it is possible to carry out the process that is the object of the invention described above and in particular the application step.

A characteristic of the invention provides that the upper chamber 510 can also comprise pressurization means to create a pressure that is even higher than the atmospheric one above the film 300.

In accordance with the invention, the upper 510 and lower 520 chambers in particular comprise means for controlling the pressure. In this way it is possible to balance the vacuum between said upper and lower chambers 510, 520, as described during the application step.

Said lower chamber 520 comprises engaging means 521 of the container 200 that are configured to insert into said lower chamber 520 at least the portion of container 200 that must be protected or at least the closing member 210 and in particular a portion below it of the body 220 so that the closing member 210 is in the proximity and below the film 300.

Said engaging means 521 of the container 200 of the lower chamber 520 are preferably configured to allow a translational movement of the container 200 for approaching/moving it away from the film 300 when the latter is held by the blocking means 530 to achieve the correct working distance.

In particular, the engaging means 521 may comprise sealing elements 522 which cooperate with the side surface 221 of the container 200.

An embodiment provides that the upper chamber 510 comprises first heating means 515 for the heating of the film 300. Said heating can take place by irradiation and/or convection and/or contact.

Also the lower chamber 520 can comprise second heating means 525 for the heating of the film 300 by irradiation and/or convection and/or contact.

In this way it is possible to distribute the heat both below and above or only above or only below the film 300 depending on, for example, the type of material of which it is made.

Furthermore, different heating systems and more than one simultaneously or in sequence can be used, depending on the material of the film 300 and with the aim of activating the thermoadhesive and/or thermoplastic and/or thermoelastic properties thereof.

For example, a preferred embodiment may be the one which provides for the first and/or the second heating means 515, 525 to be incorporated in the inner surface 511 of the application means 501. In this way, during the depressurization step, the film is preferably pushed into contact with the heated internal surface 511.

Said solution allows a more uniform and controlled heating of the film 300, compared to the one obtained with other systems, such as for example irradiation.

As shown in FIG. 4, the application means 501 preferably comprise resting means 540 adapted to support the side covering surface 311 of the film 300 which extends beyond the upper surface 211 and having a resting surface 541 that is suitable not to generate an adhesion with the film 300.

In particular, said resting means 540 are located below the interspace 222 that is present between the side surface 221 of the body 220 and the outer edge 213 of the closing member 210.

a. Furthermore, they preferably extend up to the proximity of the container 200 leaving a spacing 550 between said resting means 540 and the container 200 for the adhesion of the film 300 in the interspace 222.

The position of the resting means 540 allows the side covering surface 311 of the film 300 to be supported in place during, for example, the application step in which the vacuum is applied in the lower chamber 520. In fact, the film 300 will be attracted against the upper surface 211 of the closing member 210 and against the resting means 540.

The spacing 550 will allow the film 300 to descend below the resting means 540, thus being inserted into the interspace 222 of the container 200.

Preferably the resting surface 541 is made of anti-adhesive material to allow to easily remove the portion of excess film 300.

In order to optimize the operation of the apparatus 500, the resting means 540 can be movable between a retracted position outside the working area and an extended position for the support of the side covering surface 311 of the film 300. This allows to activate them only in the steps in which they are useful, such as the adhesion step, and avoid cluttering during the other steps.

A characteristic of the apparatus 500 shown in FIG. 5, the upper and lower chambers 510, 520 are movable one with respect to the other between a moving-away opening position A and an approaching closing position B.

This configuration promotes the insertion of the film 300 as well as making the apparatus 500 and its application means 501 accessible for inspection, maintenance, control.

Thanks to said opening A and closing B positions, it is possible to make the blocking means 530 by means of opposite surfaces 531, 532 of the upper and lower chambers 510, 520.

a. Said opposite surfaces 531, 532 can therefore be configured to hold the film 300 when the chambers 510, 520 are in the closing position B, as shown in FIG. 5.

Said solution is simple and cost-effective as it uses the movement of the chambers 510, 520 to hold the film 300.

To terminate the application process, the application means 501 preferably also comprise cutting means to cut the excess film 300 after the application to the container 200.

Said cutting means are in particular configured to leave an appendix 302 of the film 300 which remains detached from the container 200 and which is functional to defining a holding point for the user who must remove the protection device before opening the can.

It is understood however that what is described above has a value of non-limiting example, therefore, possible variants of detail that may be necessary for technical and/or functional reasons, are considered from now falling within the same protective scope defined by the claims indicated below.

1. A container (200) for food products or beverages, onto which a protection device (100) is applied, said container (200) comprising a body (220), to which a closing member (210) is firmly connected, an upper surface (211) of which may carry an opening member (212) for releasing contents contained therein, wherein said protection device (100) comprises a film (300) comprising at least one covering surface (310), each respective part or zone of which is adhering to the opposite part or zone of the surface of said container (200) to be covered and protected.

2. The container (200) according to claim 1, wherein said covering surface (310) extends to cover an entirety of the upper surface (211) of the closing member (210) of the container (200).

3. The container (200) according claim 1, wherein the film (300) comprises a side covering surface (301) that extends beyond the upper surface (211), configured to adhere to an outer edge (213) of the closing member (210) and extending and adhering along a portion of the side surface (221) of the body 33 (220) below the closing member (210).

4. The container (200) according claim 1, wherein the side covering surface (301) of the film (300) inserts in an interspace (222) that is present between the side surface (221) and an outer edge (213) of the closing member (210).

5. (canceled)

6. The container (200) according claim 1, wherein the film (300) is a film, preferably made of a plastic material, with elastoplastic properties that generate a centripetal radial force, which acts at an outer edge (213) of the closing member (213), the interspace (222), and the portion of the side surface (221).

7. The container (200) according claim 1, wherein the film (300) has adhesive properties, actuatable by heating, such that the film (300) bonds to the container (200) and is removable/peelable by tearing.

8. The container (200) according claim 1, wherein the film (300), preferably of a multi-layered type, is of the barrier type, which has a reduced permeability to gases and water vapor.

9. A process for the protection of a container (200) for food products or beverages, by a protection device (100), comprising a film (300), the process comprises:
arranging the film (300) at a surface portion to be protected, and
adhering each respective part or zone of the covering surface (310) to an opposite part or zone of the surface of said container (200) to be covered and protected.

10. The process according to claim 9, which provides for applying the protection device (100) according to at least the following steps:
positioning and holding the film (300) above and in the proximity of the closing member (210);
gradually creating a vacuum on both sides of the film (300), balancing the pressure values so that the same film (300) does not contact the closing member (210) of the container (200);
upon reaching a desired vacuum below the film (300), restoring the atmospheric pressure or a temporary overpressure above the film (330), while maintaining the vacuum below the film (300), so as to push, press, and adhere the covering surface (310) against the upper surface (211), and push, press, and adhere the side portion (301) about the outer edge (213) of the closing member (210) and on a portion of the side surface (221) of the body (220) below the closing member (210), and further inserting said side portion (301) into the interspace (222) that is present between the side surface (221) and the outer edge (213) of the closing member (210);
restoring the atmospheric pressure also below the film (300).

11. The process according to claim 9, further comprising making the film (300) suitably shapeable by means of a step of heating by at least one of: irradiation; contact; or convection, until activating at least one of its thermoadhesive properties or its thermoplastic properties.

12. The process according to claim 10, wherein the positioning step comprises inserting at least one portion of the container (200) comprising the closing member (210) and a portion of the body (220) below it, in an apparatus (500) configured to work at a controlled pressure and/or vacuum and to arrange and hold the film (300) within said apparatus (500) above and in the proximity of the closing member (210).

13.-14. (canceled)

15. An apparatus (500) for the protection of a container (200) for food products or beverages, by means of application of a protection device (100), said apparatus (500) comprises application means (501) that are configured to apply a film (300) so that each part or zone of a covering surface (310) is adherent to a respective opposite part or zone of a surface of said container (200) to be covered and protected.

16. The apparatus (500) according to claim 15, wherein the application means (501) comprise an upper chamber (510) and a lower chamber (520), configured to receive therein at least a portion of container (200) that has to be protected, and blocking means (530) configured to hold the film (300) located above a closing member (210), which is firmly connected to a body portion (220) of the container (200), in place, said upper (510) and lower (520) chambers further comprising depressurization means to create a vacuum therein above and below the film (300), respectively, and wherein the upper chamber (510) further comprises pressurization means to generate a pressure that is higher or lower than the atmospheric one above the film (300).

17. The apparatus (500) according to claim 16, wherein the upper and lower chambers (510, 520) comprise means for controlling the pressure/vacuum for balancing between said upper and lower chambers (510, 520).

18. The apparatus (500) according to claim 16, wherein the lower chamber (520) comprises engaging means (521) of the container (200) that are configured to insert into said lower chamber (520) at least the closing member (210) and a portion below it of the body (220) so that the closing member (210) is in proximity thereto and below the film (300).

19. The apparatus (500) according to claim 16, wherein at least one of: the upper chamber (510) or the lower chamber (520) comprises a first and second heating means (515, 525), respectively, for heating the film (300) by at least one of: irradiation, convection or contact.

20. The apparatus (500) according to claim 19, wherein the first and/or second heating means (515, 525) are incorporated in an inner surface (511) of the application means (501) for the heating of the film (300).

21. The apparatus (500) according to claim 16, wherein the application means (501) comprise resting means (540) suitable to support the side covering surface (301) of the film (300) that extends beyond an upper surface (211) of the closing member (210), and having a resting surface (541) that is suitable not to generate an adhesion with the film (300).

22. The apparatus (500) according to claim 21, wherein the resting means (540) are located below an interspace (222) that is present between a side surface (221) and an outer edge (213) of the closing member (210) and extend towards the container (200), leaving a spacing (550) between said resting means (540) and the container (200) for adhesion of the film (300) into the interspace (222).

23. (canceled)

24. The apparatus (500) according to claim 16, wherein the upper and lower chambers (510, 520) are movable one with respect to the other between a moving-away opening position (A) and an approaching closing position (B) to promote insertion of the film (300).

25.-27. (canceled)
